(19) United States
(12) Patent Application Publication
(10) Pub. No.: US 2022/0291076 A1
(43) Pub. Date: Sep. 15, 2022

(54) LEAKAGE DETECTION UNIT WITH VARIABLE SIZE ORIFICE

(71) Applicants: KABIR BHANDARI, NEW DELHI (IN); AMARDIP KUMAR, GURGAON (IN); KUMAR ABHISHEK, Gurgaon (IN); ABHIJATYA GUPTA, Gurgaon (IN)

(72) Inventors: KABIR BHANDARI, NEW DELHI (IN); AMARDIP KUMAR, GURGAON (IN); KUMAR ABHISHEK, Gurgaon (IN); ABHIJATYA GUPTA, Gurgaon (IN)

(21) Appl. No.: 17/695,571

(22) Filed: Mar. 15, 2022

(30) Foreign Application Priority Data
Mar. 15, 2021 (IN) 202111010962

(51) Int. Cl. G01M 3/32

(52) U.S. Cl. CPC G01M 3/3236; G01M 3/3209

(57) ABSTRACT

The present invention relates to leakage detection unit (100) comprise of an upper housing (5), a lower housing (6) accommodating an electromechanical valve (1), a pump assembly (2), a pressure sensor (3) and a bush (4), wherein the pump assembly (2) includes a pump that permits flow of air that, due to which pressure in passage of the pump becomes constant after a time interval and that pressure is considered as reference pressure. The pressure is measured by help of the pressure sensor (3) and in case the measured pressure is not equal or above to the reference pressure than there is leakage in the isolation valve (100), whereas in case the measured pressure is equal or above the reference pressure that there is no leakage or some permissible amount of leakage in the fuel tank within the time interval.

### FIELD OF THE INVENTION

The present invention relates to a leakage detection unit. More particularly, the present invention relates to a fuel tank leakage detection unit with variable size orifice that has a bush with orifice of variable diameter which is adaptable according to the requirements that results in enhanced flexibility.

### BACKGROUND OF THE INVENTION

A fuel tank acts a safe container specially for flammable liquids like petrol, diesel and the fuel tanks are widely used in vehicles to store the fuel in which the stored fuel is propelled through a fuel pump or releases by pressurization method and also maintain temperature of the stored fuel. The fuel tanks are manufactured according to size and complexity, for instance in lighters, fuel tanks are small and made up of plastic, whereas in vehicle complex fuel tanks are used. Fuel tank generally comprise of pressure pumps, accumulator, nozzle and fuel injector. Numerous varieties are present in the fuel tanks for instance, single wall, double wall, integral, removable tank depending on requirements.

While manufacturing a fuel tank, some processes are carefully conducted such as shearing welding and bending so that the fuel tank is leak proof. Leaks in fuel tank happens when the fuel tank gets old or presence of rots and then the fuel tanks is replaced with a new safe tank to reduce the chances of fire because fuel stored in the tanks are highly flammable, hence it is important to monitor and detect leakage in the fuel tank. Moreover, emission of gases like carbon monoxide is dangerous for human health and if inhaled then it may cause harm such serve headache and nausea.

In the fuel tank, fuel vapours are needed to be stored, so that vapour emission control system in the hybrid vehicle smoothly functions the intended operations. According to challenges, improvements are done in the fuel tank to meet the terms of environmental and safety rules and regulations, due to which the complexity is increased of the existing fuel tank.

Several devices and systems are available in the market for detecting leakage in the fuel tank. One of the widely used device is an oil leak detection alarm that are designed to observe regions/zones for oil leaks or spillages from the tank or any other equipment. Moreover, the current leak detection units work on a rigid size of orifice due to which these devices are less flexible. The orifice is used to control the amount of flow and when the diameter of the orifice is increased, the amount of flow is also enhanced as the pressure rate inside the valve decreases and it requires more amount of force to lift the plunger off the orifice, hence, the size of the orifice is directly proportional to the amount of flow. The issue of rigid orifice leads to decrease in efficiency and increase in cost. Additionally, for detecting leakage in the fuel tank various leakage detection routines are performed on fuel system of the vehicle which increase cost and time.

CN203745155U discloses of fuel tank comprehensive leakage detection platform mainly comprises a base, a main water tank and a control unit, the main water tank is arranged on the base, the base is provided with a vacuum pump, the vacuum pump is connected with the control unit, when a vacuum value in the fuel tank reaches a set value of the control unit, the control unit automatically cuts off power, and the vacuum pump can be switched off. But this invention does not have provision of variable size orifice for detecting fuel vapor leakage from fuel tank. This invention does not provide efficient flexibility according to the requirements.

US20030051540A1 discloses of fuel vapor control system has a controller that carries out a leak check processing after the engine is stopped. The controller includes a device that intermittently activates the controller itself or a part of the controller to sample an internal pressure of the fuel vapor passage. Then, after a predetermined time, the controller determines that whether the sampled values of the internal pressure indicate a leak or not by evaluating the sampled values. But the drawbacks of this invention is that the technique of detecting leakage in the valve is not efficient.

Therefore, there is a need of improvement in the leakage detection technology, by providing a leakage detection unit with variable size orifice that has a bush with orifice of variable diameter that is adaptable according to the requirements that results in boosted flexibility.

### OBJECT OF THE INVENTION

The main object of the present invention is to provide a leakage detection unit for fuel tank with variable size orifice that enable engine control unit to monitor precise leakage.

Another object of the present invention is to provide a leakage detection unit adapted for fuel tanks with variable orifice for detecting leakage of fuel vapor.

Yet another object of the present invention is to provide a leakage detection unit that has a bush with orifice of variable diameter.

Yet another object of the present invention is to provide a leakage detection unit with a pressure sensor integrated pump for sensing pressure of inside fuel tank.

Still another object of the present invention is to provide a leakage detection unit with variable size orifice that ensures high flexibility.

### SUMMARY OF THE INVENTION

The present invention relates to a leakage detection unit for fuel tank with variable size orifice for detecting leakage of fuel vapor from a fuel tank that is highly flexible in nature.

In an embodiment, the present invention provides a leakage detection unit with variable size orifice comprising of an upper housing and a lower housing accommodating an electromechanical valve and a pump assembly. Said electromechanical valve operates opening and closing operations of a canister port in a fuel tank according to a feedback provided by an engine control unit. The pump assembly includes a pump that is mounted on a shaft of a motor that provides rotational movement to the pump. The leakage detection unit has a pressure sensor that is integrated with the pump for sensing pressure of inside the fuel tank along with a bush, wherein the bush is with an orifice of variable diameter.

In another embodiment, the present invention provides a leakage detection unit with variable size orifice which in inactive or OFF state, blows air from atmosphere to the fuel tank that passes through a canister. In active or ON state, a pump included in the pump assembly starts flow of air that reaches to the fuel tank by passing through the orifice, due to which pressure in passage of the pump becomes constant after a certain time interval and that pressure is considered as reference pressure. The electromechanical valve gets active that permits flow of air from the orifice as well as a solenoid port to a canister. The pressure is measured by the help of the pressure sensor that is integrated within the pump, in case the measured pressure is not equal or above to the reference pressure than there is leakage in the fuel tank, whereas in case the measured pressure is equal or above the reference pressure that there is no leakage or some permissible amount of leakage.

The above objects and advantages of the present invention will become apparent from the hereinafter set forth brief description of the drawings, detailed description of the invention, and claims appended herewith.

### BRIEF DESCRIPTION OF THE DRAWINGS

An understanding of the leakage detection unit with variable size orifice of the present invention may be obtained by reference to the following drawings:

FIG. 1 is a cross-sectional view of a leakage detection unit with variable size orifice according to an embodiment of the present invention.

FIG. 2 is a flow chart of working of a leakage detection unit with variable size orifice according to an embodiment of the present invention.

FIG. 3 is a graph depicting variation of time taken to arrive at reference pressure buildup in the fuel tank with variable size orifice according to an embodiment of the present invention.

### DETAILED DESCRIPTION OF THE INVENTION

The present invention will now be described hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention provides a leakage detection unit (100) for fuel tank with variable size orifice that has a pressure sensor integrated pump and a bush (4) with orifice for detecting considerable amount of leakage present in the fuel tank that provided enhanced flexibility.

In the main embodiment, the present invention provides a leakage detection unit (100) with variable size orifice comprising of an upper housing (5) and a lower housing (6) accommodating an electromechanical valve (1), a pump assembly (2), wherein the electromechanical valve (1) comprises of a pressure sensor (3) for sensing pressure inside the fuel tank along with a bush (4) in which the bush (4) is having an orifice of variable diameter. The pump assembly (2) includes a pump that is mounted on a shaft of a motor (7) that provides rotational movement to the pump. The pressure sensor (3) is integrated in the pump. In inactive or OFF state, air from atmosphere is blown to the fuel tank that passes through a canister and the fuel tank. In active or ON state, a pump included in the pump assembly starts flow of air that reaches to the fuel tank by passing through the orifice, due to which pressure in passage of the pump becomes constant after a certain time interval and that pressure is considered as reference pressure. The electromechanical valve (1) gets active that permits flow of air from the orifice as well as a solenoid port to the canister. The pressure is measured and in case the measured pressure is below the reference pressure then there is leakage in the fuel tank, whereas in case the measured pressure is equal or above the reference pressure then there is no leakage or some permissible amount of leakage in the fuel tank.

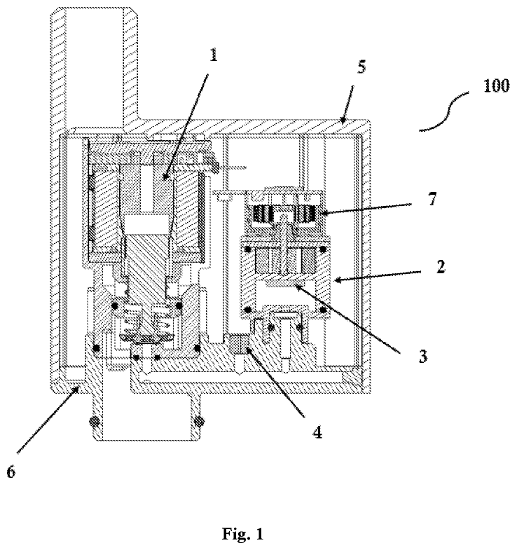

Referring to FIG. 1, a cross-sectional view of leakage detection unit (100) is illustrated that comprises of an upper housing (5), a lower housing (6) accommodating an electromechanical valve (1), a pump assembly (2), a pressure sensor (3) and a bush (4). The electromechanical valve (1) used herein is a switchover valve for opening and closing a canister port according to signals provided by the engine control unit (ECU). The pump assembly (2) includes a vane type pump mounted on shaft of a motor (7). The motor (7) preferably is a brushless DC electric motor for giving rotational input to the pump. The pressure sensor (3) is integrated within the pump for sensing the pressure inside the fuel tank. The bush (4) is associated with an orifice and press fit in the passage. The orifice is of variable diameter and the diameter depends on the requirements that ensures high flexibility. The diameter of orifice varies from range 0.3 mm to 1.0 mm.

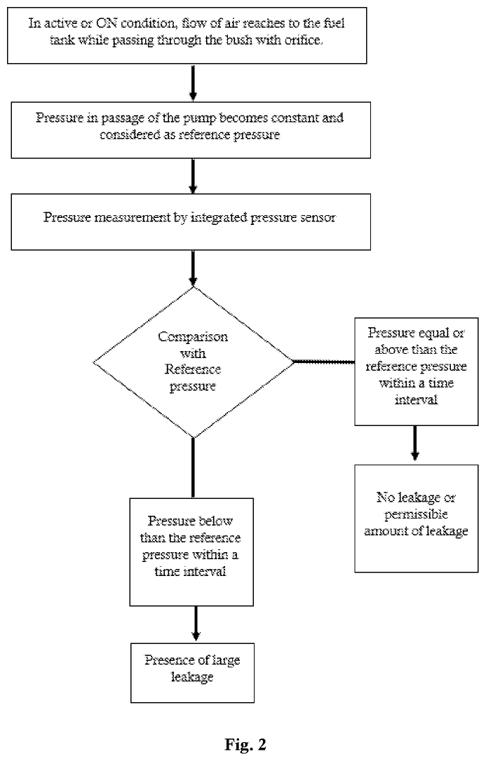

Referring to FIG. 2, a flow chart of working of the leakage detection unit (100) is illustrated. Initially in inactive or OFF state, air from atmosphere is blown to the fuel tank that passes through a canister, whereas in active or ON state, the pump included in the pump assembly (2) permits the flow of air that reaches to the fuel tank while passing through the bush (4) with orifice, due to which pressure in passage of the pump becomes constant after a certain time interval and that pressure is considered as reference pressure. Then the electromechanical valve (1) gets active that permits flow of air from the orifice as well as a solenoid port to the canister. The pressure is measured by the pressure sensor (3) present inside the pump. In case the measured pressure inside the fuel tank is below the reference pressure then there is leakage in the fuel tank, whereas in case the measured pressure is equal to or above the reference pressure then there is no leakage or some permissible amount of leakage, respectively. In case of variation in diameter of orifice, the reference pressure and time interval also change.

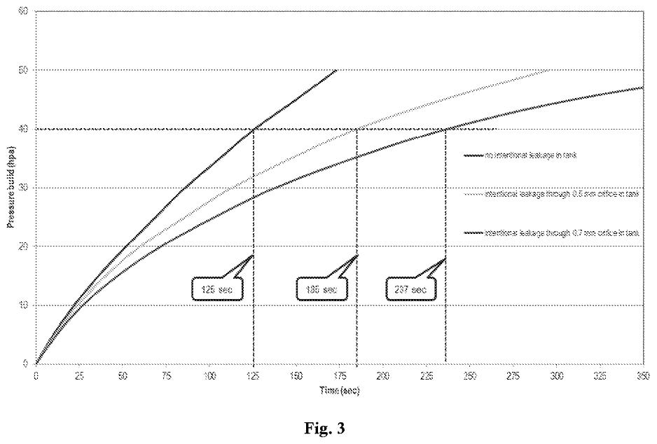

Referring to FIG. 3, a graphical representation of time taken to arrive at reference pressure buildup in the fuel tank is depicted. It may be noted that the time taken to arrive at reference pressure is the least when no leakage is detected in the fuel tank. In an embodiment, in inactive or OFF state, air from the atmosphere is blown to the fuel tank that passes through the canister. When the leakage detection unit (100) detects no leakage in the fuel tank, the time taken to build the reference pressure is lesser as compared to the time taken to build reference pressure when leakage is detected. In an embodiment, the leakage detection unit (100) is adapted for accommodating a bush (4) with an orifice of selected diameter.

It may be noted from FIG. 3 that when the leakage detection unit (100) is adapted for an orifice of size 0.5 mm, the time taken to arrive at reference pressure increases to 185 seconds. Further, it may be noted from FIG. 3 that when the leakage detection unit (100) is adapted for an orifice of diameter 0.7 mm, the time taken to arrive at reference pressure increase to 237 seconds.

In an embodiment of the invention, the leakage detection unit (100) with variable size orifice is capable of modification. The size of orifice varies for various manufacturers for complying to emission norms laid by the government. The leakage detection unit (100) of present invention comprise a bush (4) with variable size orifice. The bush (4) is associated with the orifice in the passage. The bush (4) with orifice of selected diameter is press fit in the passage of the pump. Diameter of the orifice is selected to be in compliance with permissible leakage limit for selected fuel tank. In accordance with the teachings of present invention, the provision of bush (4) with variable size orifice allows flexibility. In an embodiment, the bush (4) is selected to be with diameter of the orifice as 0.3 mm, 0.4 mm, 0.5 mm, 0.6 mm, 0.7 mm, 0.8 mm, 0.9 mm or 1.0 mm. It may be noted that the flexibility in selecting the bush (4) with the selected diameter of orifice allows to modify the fuel detection unit (100) as per requirement.

In an embodiment, value of reference pressure and the time required to arrive at the reference pressure for a selected diameter of orifice changes with selected diameter.

In an embodiment, in an active or ON state when the pump of the pump assembly (2) is turned on, air starts flowing through the pump to reach the fuel tank while passing through the bush (4) with orifice of selected diameter. The pressure in the pump passage becomes constant after a fixed time interval for the bush (4) with orifice of selected diameter. The pressure thus built up is taken as reference pressure. However, in the next stage, the electromechanical valve (1) provided in the leakage detection unit (100) is activated permitting air to flow from the orifice as well as the solenoid port to the canister. If there is a leakage in the fuel tank, then the pressure will not build up to the value of reference pressure within the fixed time interval. In case of no leakage or permissible leakage, the pressure build up will reach above or equal the reference value, respectively, within the fixed time interval.

### EXAMPLE 1

### Experimental Analysis

As an example, the diameter of orifice associated with the bush (4) is selected to be 0.5 mm. The bush (4) being press fit in passage of the pump. In an inactive or OFF state, the leak detection unit sends fresh air from the atmosphere to the fuel tank. The air passes through canister and fuel tank isolation valve before reaching the fuel tank whereas in active or ON state, the pump included in the pump assembly (2) permits the flow of air that reaches to the fuel tank while passing through the bush (4) with orifice, due to which pressure in passage of the pump becomes constant after a certain time interval. In accordance with present invention the time taken to arrive at reference pressure increased to 185 seconds indicating leakage in the fuel tank.

As another example, the diameter of orifice associated with the bush (4) is selected to be 0.7 mm. The bush (4) being press fit in passage of the pump. In an inactive or OFF state, the leak detection unit sends fresh air from the atmosphere to the fuel tank. The air passes through canister and fuel tank isolation valve before reaching the fuel tank whereas in active or ON state, the pump included in the pump assembly (2) permits the flow of air that reaches to the fuel tank while passing through the bush (4) with orifice, due to which pressure in passage of the pump becomes constant after a certain time interval. In accordance with present invention the time taken to arrive at reference pressure increased to 237 seconds indicating leakage in the fuel tank.

In an embodiment, the pressure builds up in the fuel tank will not reach up to the value of reference pressure within the time interval if there is leakage detected in the fuel tank. It may be noted that the value of reference pressure and the time interval required to arrive at the reference pressure for a selected diameter of orifice changes with selected diameter.

The fuel leakage detection unit of present invention is adaptable to be used in vehicles with different diameter of passage provided by different manufacturers. Thus, the invention provides a flexible structure of leakage detection unit. The invention is economically significant to the manufacturers by avoiding to manufacture whole leakage detection unit for various emission standards laid by the government in different territories. The leakage detection unit (100) of present invention can readily be fitted in any vehicle as required in accordance with the size of orifice of the passage. Therefore, the present invention provides a leakage detection unit with variable size orifice that has a bush (4) with orifice of variable diameter for detecting leakage of fuel vapor along with a pressure sensor integrated pump for sensing pressure of inside fuel tank. The provision of bush (4) with variable size orifice guarantees great flexibility.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A leakage detection unit (100) for detecting leakage in a fuel tank in a vehicle, the leakage detection unit (100) comprising:
an upper housing (5);
a lower housing (6);
an electromechanical valve (1);
a pump assembly (2) including a vane type pump mounted on shaft of a motor (7) to provide rotational input to the pump;
a pressure sensor (3); and
a bush (4) associated with an orifice of variable diameter;
wherein:
the upper housing (5) and the lower housing (6) are joined to accommodate the electromechanical valve (1), the pump assembly (2), the pressure sensor (3), the motor (7) and the bush (4);
the electromechanical valve (1) is a switchover valve for opening and closing a canister port according to signals provided by engine control unit;
the pressure sensor (3) is integrated within the pump for sensing pressure inside the fuel tank; and
the bush (4) is press fitted in an orifice of desired diameter selected as per requirement of emission.

2. The leakage detection unit (100) as claimed in claim 1 wherein, in inactive or OFF condition, air from the atmosphere that passes through the canister is blown to the fuel tank.

3. The leakage detection unit (100) as claimed in claim 1 wherein, in active or ON condition, the pump included in the pump assembly (2) permits the flow of air that reaches to the fuel tank while passing through the bush (4) with orifice of selected diameter ranging from 0.3 mm to 1.0 mm.

4. The leakage detection unit (100) as claimed in claim 1 wherein, in active or ON state, the electromechanical valve (1) gets active that permits flow of air from the orifice as well as solenoid port to canister.

5. The leakage detection unit (100) as claimed in claim 1 wherein, pressure in passage of the pump becomes constant after certain time interval and that pressure is considered as reference pressure.

6. The leakage detection unit (100) as claimed in claim 1 wherein, no leakage takes place when the measured pressure inside the fuel tank is below a reference pressure, whereas in case the measured pressure is equal to or above the reference pressure then either there is no leakage or some permissible amount of leakage, respectively.

7. The leakage detection unit (100) as claimed in claim 1 wherein, the bush (4) with orifice of selected diameter is press fit in passage of the pump.

8. The leakage detection unit (100) as claimed in claim 1 wherein, diameter of the orifice is selected to be in compliance with permissible leakage limit for selected fuel tank.

9. The leakage detection unit (100) as claimed in claim 1 wherein, value of reference pressure and the time required to arrive at the reference pressure for a selected diameter of orifice changes with selected diameter.
